(19) United States
(12) Patent Application Publication
(10) Pub. No.: US 2017/0280262 A1
(43) Pub. Date: Sep. 28, 2017

(54) ELECTRONIC DEVICE, DETECTION DEVICE AND METHOD FOR SETTING OUTPUT OF HEADSET

(71) Applicant: Acer Incorporated, New Taipei City (TW)

(72) Inventors: Po-Jen TU, New Taipei City (TW); Jia-Ren CHANG, New Taipei City (TW); Ming-Chun YU, New Taipei City (TW); Kuei-Ting TAI, New Taipei City (TW); Kai-Meng TZENG, New Taipei City (TW)

(21) Appl. No.: 15/362,717

(22) Filed: Nov. 28, 2016

(30) Foreign Application Priority Data
Mar. 28, 2016 (TW) 105109651

(51) Int. Cl. H04R 29/00

(52) U.S. Cl. CPC H04R 29/001

(57) ABSTRACT

An electronic device is provided in the invention. The electronic device includes a first connection interface, a second connection interface, a processor and a storage device. The first connection interface is coupled to a third connection interface of a detection device by a headset connector to receive an oscillation signal and headset output signal corresponding to a detection-source signal from the detection device, and transmits the detection-source signal to the detection device. The second connection interface is coupled to a fourth interface to transmit a control signal to the detection device. The processor is coupled to the first connection interface and second connection interface, and obtains the microphone information according to the oscillation signal, and obtains the headset information according to measured headset signals and the microphone information. The storage device is coupled to the processor to store the microphone information and the headset information.

### CROSS REFERENCE TO RELATED APPLICATIONS

This Application claims priority of Taiwan Patent Application No. 105109651, filed on Mar. 28, 2016, the entirety of which is incorporated by reference herein.

### BACKGROUND OF THE INVENTION

Field of the Invention

The invention generally relates to a technology for setting the output of a headset, and more particularly, to a technology for setting the output of a headset by obtaining the headset output signal corresponding to each volume level of the electronic device and performing a secure setting for the output of the headset.

Description of the Related Art

In conventional headset technology, standards for the maximum headset output voltage of the electronic device are formulated to protect the user's hearing. For example, in the EN50332 standard formulated by the European Union (EU), when the detection source is −10 dB pink noise, the maximum headset output voltage must be lower than the save voltage (150 mV).

However, in many conventional electronic devices, the output voltage set in these electronic devices may still be higher than the range of the save voltage. In addition, in different nations, different standards and verifications may be formulated to manage the electronic devices. Therefore, when a nation selling the electronic device has not formulated a standard, the maximum headset output voltage of the electronic device may be higher than the save voltage. As a result, the user's hearing may be impaired.

### BRIEF SUMMARY OF THE INVENTION

A wireless communication method and device are provided to overcome the problems mentioned above.

An embodiment of the invention provides an electronic device. The electronic device comprises a first connection interface, a second connection interface, a processor and a storage device. The first connection interface couples to a third connection interface of a detection device through a headset connector to receive an oscillation signal and a plurality of headset output signals corresponding to detection-source signals from the detection device and transmit the detection-source signals to the detection device. The second connection interface couples to a fourth connection interface of the detection device and transmits a control signal to the detection device. The processor couples to the first connection interface and the second connection interface, obtains microphone information according to the oscillation signal and obtains headset information according to a plurality of measured headset signals and the microphone information. The storage device couples to the processor and stores the microphone information and the headset information.

An embodiment of the invention provides a method for setting the output of a headset. The method is applied to an electronic device. The method comprises the steps of coupling the electronic device to a detection device; receiving an oscillation signal from the detection device; generating microphone information according to the oscillation signal; transmitting detection-source signals to the detection device; receiving a plurality of headset output signals corresponding to detection-source signals from the detection device; generating a plurality of measured headset signals corresponding to the plurality of headset output signals; obtaining headset information according to the plurality of measured headset signals and the microphone information; and performing a secure setting for the output of the headset of the electronic device according to the headset information.

An embodiment of the invention provides a method for setting the output of a headset. The method is applied to a detection device. The method comprises the steps of coupling the detection device to an electronic device; receiving a first control signal from the electronic device; generating an oscillation signal; transmitting the oscillation signal to the electronic device; receiving a second control signal from the electronic device; receiving detection-source signals respectively corresponding to different volume levels from the electronic device; and generating a plurality of headset output signals, wherein the plurality of headset output signals corresponds to detection-source signals respectively corresponding to different volume levels. In the embodiment, the electronic device generates microphone information and headset information according to the oscillation signal and the plurality of headset output signals, and performs a secure setting for the output of the headset of the electronic device according to the headset information.

Other aspects and features of the invention will become apparent to those with ordinary skill in the art upon review of the following descriptions of specific embodiments of wireless communication methods and devices.

### BRIEF DESCRIPTION OF THE DRAWINGS

The invention will become more fully understood by referring to the following detailed description with reference to the accompanying drawings, wherein:

FIG. 1 is a block diagram of an electronic device 100 according to an embodiment of the invention;

FIG. 2 is a block diagram of a detection device 200 according to an embodiment of the invention;

FIG. 3 is a schematic diagram of a headset connector 300 according to an embodiment of the invention;

FIG. 4A and FIG. 4B are schematic diagrams for generating the control signal S1 according to an embodiment of the invention;

FIG. 5 is a flow chart 500 illustrating the method for setting the output of the headset according to an embodiment of the invention;

FIG. 6 is a flow chart 600 illustrating the method for setting the output of the headset according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

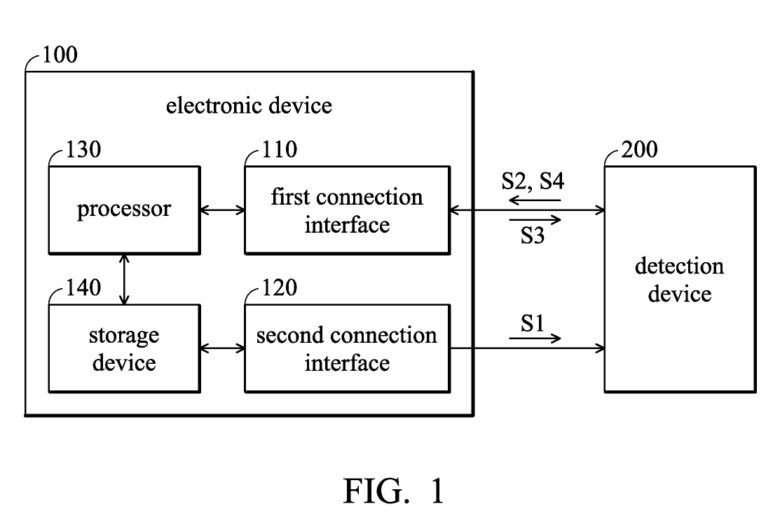

FIG. 1 is a block diagram of an electronic device 100 according to an embodiment of the invention. The electronic device 100 may be a computer host, a note book, a tablet, a mobile, a mobile/portable device, etc. As shown FIG. 1, the electronic 100 comprises a first connection interface 110, a second connection interface 120, a processor 130, and a storage device 140. Note that, in order to clarify the concept of the invention, FIG. 1 presents a simplified block diagram in which only the elements relevant to the invention are shown. However, the invention should not be limited to what is shown in FIG. 1. The electronic device 100 can also comprise other elements.

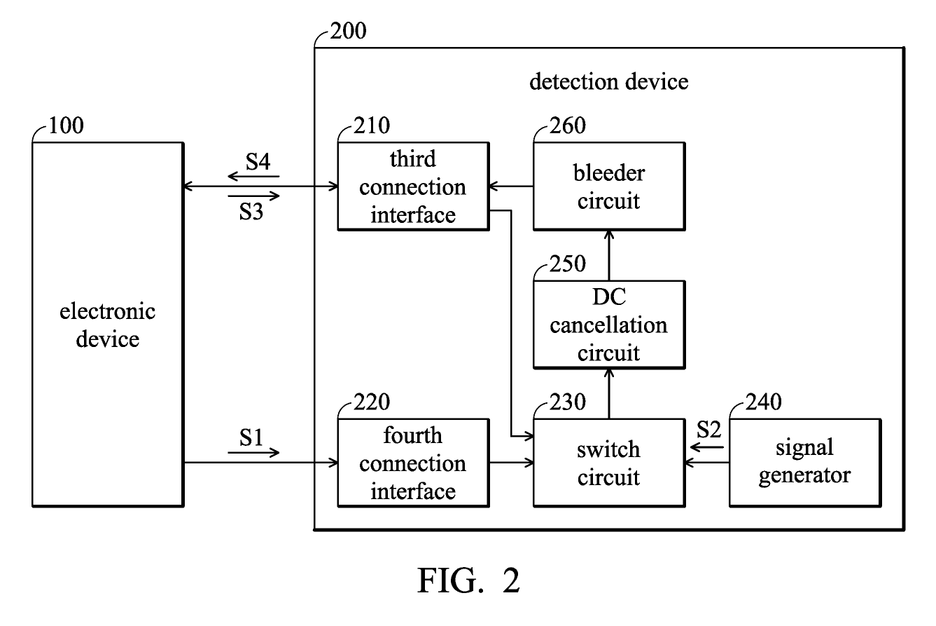

FIG. 2 is a block diagram of a detection device 200 according to an embodiment of the invention. As shown FIG. 2, the detection device 200 comprises a third connection interface 210, a fourth connection interface 220, a switch circuit 230, a signal generator 240, a direct-current (DC) cancellation circuit 250 and a bleeder circuit 260. Note that, in order to clarify the concept of the invention, FIG. 2 presents a simplified block diagram in which only the elements relevant to the invention are shown. However, the invention should not be limited to what is shown in FIG. 2. The detection device 200 can also comprise other elements.

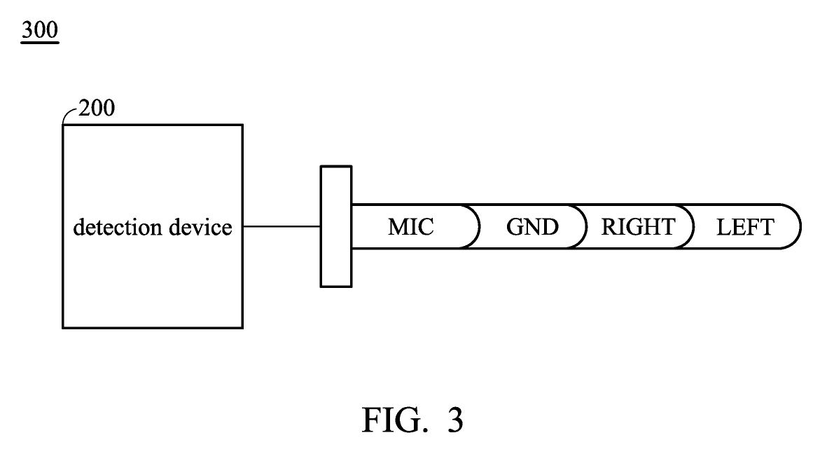

As shown FIG. 1, the first connection interface 110 is coupled to the processor 130. In an embodiment of the invention, when the electronic device 100 is detected, the first connection interface 110 of the electronic device 100 may be coupled to the third connection interface 210 of the detection device 200 by a headset connector 300. In an embodiment of the invention, the first connection interface 110 corresponds to the female of the headset connector 300 and the third connection interface 210 corresponds to the male of the headset connector 300. FIG. 3 is a schematic diagram of a headset connector 300 according to an embodiment of the invention. As shown in FIG. 3, the headset connector 300 may be a 4-pins headset connector, wherein the 4 pings are MIC, GND, RIGHT and LEFT. In an embodiment of the invention, when the first connection interface 110 of the electronic device 100 has been coupled to the third connection interface 210 of the detection device 200 by the headset connector 300, the processor 130 may determine that the detection device 200 is a headset device with a microphone. That is to say, the processor 130 may identify the detection device 200 as a headset device with a microphone.

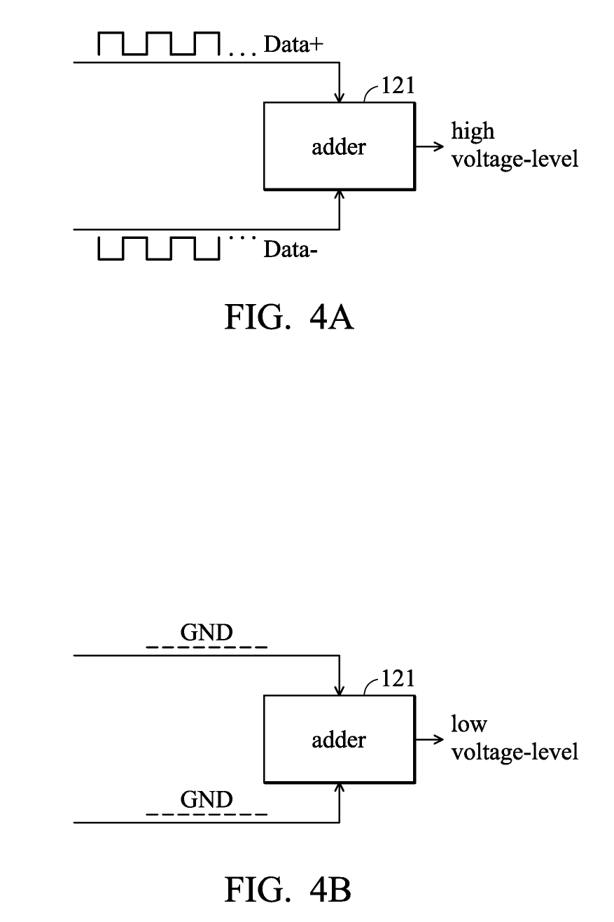

As shown in FIG. 1, the second connection interface is coupled to the processor 130. In an embodiment of the invention, the second connection interface 120 and the fourth connection interface 220 are General-purpose input/output (GPIO), such as a Universal Serial Bus (USB) interface. When the electronic device 100 is detected, the second connection interface 120 is coupled to the fourth connection interface 220 to transmit the control signal S1 generated by the processor 130 to the detection device 200 through the fourth interface 220. FIG. 4A and FIG. 4B are schematic diagrams for generating the control signal S1 according to an embodiment of the invention. As shown in FIG. 4A and FIG. 4B, the second connection interface 120 further comprises an adder 121. When the processor 130 transmits differential signals (e.g. Data+ or Data− as shown by the solid line in FIG. 4A) the differential signals will be added by the adder 121 to generate a high voltage-level control signal; and when the processor 130 transmits ground signals GND (e.g. as shown by the dashed line in FIG. 4B) the ground signals GND will be added by the adder 121 to generate a low voltage-level control signal. When the fourth connection interface 220 receives the control signal S 1, the fourth connection interface 220 may transmit the control signal S1 to the switch circuit 230. The switch circuit 230 may determine that the DC cancellation circuit 250 will be coupled to the third connection interface 210 or to the signal generator 240 according to the control signal S1. Details for determining whether the DC cancellation circuit 250 will be coupled to the third connection interface 210 or to the signal generator 240 will be discussed below.

As shown in FIG. 1, the storage device 140 is coupled to the processor 130. According to embodiments of the invention, the storage device 140 is utilized to store the software code, firmware code, system data, user data, and so on in the electronic device 100. The storage device 140 is a volatile memory (e.g. random access memory (RAM)), a non-volatile memory (e.g. flash memory, read only memory (ROM)), a hard disc, or a combination of the memory devices listed above.

As shown above, in an embodiment of the invention, when the electronic device 100 is detected, the first connection interface 110 of the electronic device 100 is coupled to the third connection interface 210 of the detection device 200 by a headset connector 300 and the second connection interface 120 of the electronic device 100 is coupled to the fourth connection interface 220 of the detection device 200. Then, the processor 130 will enable a recording device (or a recording module which is not shown in figures) and transmit the control signal S1 to the detection device 200 through the second connection interface 120. In an embodiment of the invention, the recording device is coupled to the processor 130. The recording device is an independent circuit or integrated in the processor 130. The recording device may record a microphone signal and a plurality of measured headset signals. Specifically, the voltage values of the microphone signal and the measured headset signals recorded by the recording device means the real voltage values of the microphone signal and headset signal measured by the electronic device 100.

In an embodiment of the invention, the processor 130 may transmit a high voltage-level control signal S1 (first control signal) to the fourth connection interface 220 through the second connection interface 120 first. Then, the fourth connection interface 220 may transmit the control signal S1 to the switch circuit 230. When the switch circuit 230 receives the high voltage-level control signal S1, the switch circuit 230 may couple the DC cancellation circuit 250 to the signal generator 240. In an embodiment of the invention, the signal generator 240 may be an RC-oscillator. The signal generator 240 may generate an oscillation signal S2 and then transmit the oscillation signal S2 to the DC cancellation circuit 250 to cancel the DC component of the oscillation signal S2. Then, the oscillation signal S2 which has canceled the DC component will be transmitted to the bleeder circuit 260 to perform the voltage-division process. After the voltage-division process, the oscillation signal S2 will be transmitted to the first connection interface 110 through the third connection interface 210. After the first connection interface 110 transmits the oscillation signal S2 to the processor 130, the processor 130 may obtain the microphone information (or microphone-path information) according to the microphone signal and the oscillation signal S2, wherein the microphone signal corresponds to the oscillation signal S2 and is recorded by the recording device. For example, if the oscillation signal S2 is a 100 mV signal and the microphone signal recorded by the recording device is a 200 mV signal, the processor 130 can know the microphone gain (i.e. microphone information) is 2 according to the oscillation signal S2 and the microphone signal. After the processor obtains the microphone information, the microphone information will be stored in the storage device 140.

In an embodiment of the invention, when obtaining the microphone information, the processor 130 may enable a playing device to play detection-source signals S3 (e.g. −10 dB pink noise at different volume levels) and transmit a low voltage-level control signal S1 (second control signal) to the fourth connection interface 220 through the second connection interface 120. Then, the fourth connection interface 220 may transmit the control signal S1 to the switch circuit 230. When the switch circuit 230 receives the low voltage-level control signal S1, the switch circuit 230 may couple the DC cancellation circuit 250 to the third connection interface 210. The third connection interface 210 may receive the detection-source signals S3 corresponding to different volume levels (i.e. different volume) from the playing device. The third connection interface 210 may transmit the received detection-source signals S3 to the DC cancellation circuit 250 to cancel the DC component of the detection-source signals S3. Then, the detection-source signals S3 which have canceled the DC component will be transmitted to the bleeder circuit 260 to perform the voltage-division process to generate a plurality of headset output signals S4. Note that, at this stage, the voltage values of the headset output signals S4 are still unknown. That is to say, the headset information measured later will be regarded as the voltage values of the headset output signals S4. In an embodiment of the invention, each headset output signal S4 may correspond to one of the detection-source signals S3 which corresponded to different volume levels respectively. The headset output signals S4 may be transmitted to the first connection interface 110 through the third connection interface 210.

After the first connection interface 110 transmits the headset output signals S4 to the processor 130, the processor 130 can obtain headset information (or headset path information) according to the measured headset signals and microphone information, wherein the measured headset signals correspond to the headset output signals S4 and are recorded by the recording device. In an embodiment of the invention, each of the measured headset signals recorded by the recording device corresponds to different headset output signal S4, i.e. the measured headset signals also respectively correspond to different detection-source signals S3 corresponding to different volume levels. For example, if the measured headset signals corresponding to the detection-source signals S3 corresponding to different volume levels are respectively set as follows: in level L0, the voltage of the measured headset signal is 600 mV, in level L1, the voltage of the measured headset signal is 300 mV, in level L2, the voltage of the measured headset signal is 100 mV, and in level L3, the voltage of the measured headset signal is 50 mV, and the processor 130 knows that the microphone gain is 2 according to the microphone information, the processor 130 may derive the unknown voltages (i.e. headset information) of the headset output signals S4 corresponding to different volume levels according to the measured headset signals recorded by the recording device and the microphone information, i.e. in level L0, the voltage of the headset output signals S4 is 300 mV, in level L1, the voltage of the headset output signals S4 is 150 mV, in level L2, the voltage of the headset output signals S4 is 50 mV, and in level L3, the voltage of the headset output signals S4 is 25 mV.

In an embodiment of the invention, after the processor obtains the headset information, the processor 130 can performing a secure setting for the output of the headset of the electronic device 100 according to the headset information. For example, if according to the headset information, in level L0, the voltage of the headset output signals S4 is 300 mV, in level L1, the voltage of the headset output signals S4 is 150 mV, in level L2, the voltage of the headset output signals S4 is 50 mV, and in level L3, the voltage of the headset output signals S4 is 25 mV, the processor 130 may allow the use of the level whose corresponding voltage is lower than the 150 mV (i.e. level L1˜level L3) because the save voltage is 150 mV. In addition, when the output of the headset of the electronic device 100 has been set by the secure setting, whether any headset model is used with the electronic device 100, the electronic device 100 can adopt the secure setting. That is to say, after the output of the headset of the electronic device 100, when the electronic device 100 is used to listen to the source signals through the headset, the electronic device 100 will not need to be re-connected with the detection device 200 to perform a secure setting for the output of the headset of the electronic device 100.

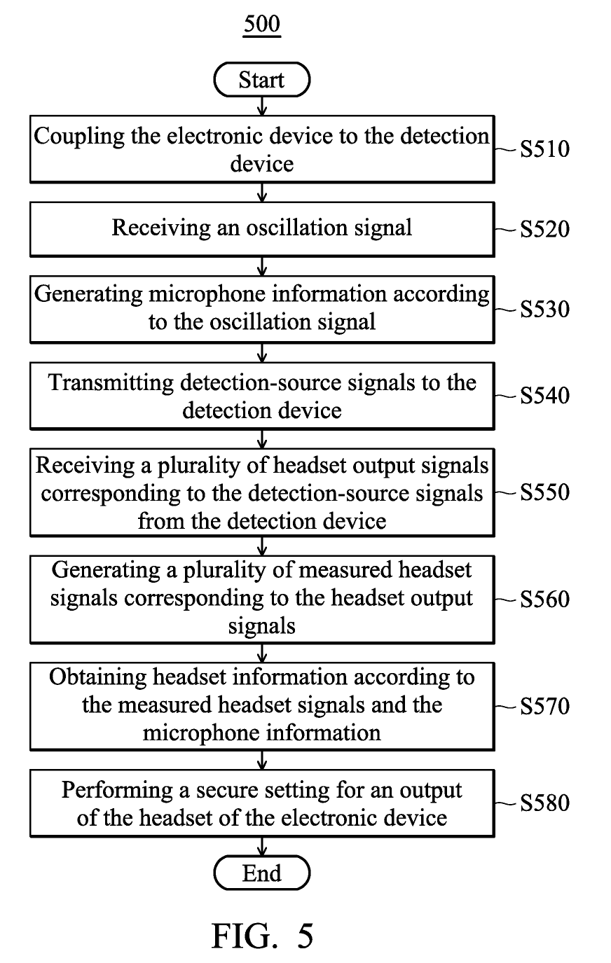

FIG. 5 is a flow chart 500 illustrating the method for setting the output of the headset according to an embodiment of the invention. The method for setting the output of the headset is applied to the electronic device 100. As shown in FIG. 5, in step S510, the electronic device 100 is coupled to the detection device 200. In step S520, an oscillation signal is received from the detection device 200. In step S530, microphone information is generated according to the oscillation signal by the electronic device 100. In step S540, detection-source signals are transmitted from the electronic device 100 to the detection device 200. In step S550, a plurality of headset output signals corresponding to the detection-source signals are received from the detection device 200 by the electronic device 100. In step S560, a plurality of measured headset signals corresponding to the headset output signals are generated by the electronic device 100. In step S570, headset information is obtained according to the measured headset signals and the microphone information. In step S580, a secure setting is performed for an output of the headset of the electronic device 100.

In an embodiment of the invention, step S530 further comprises the steps of recording a microphone signal corresponding to the oscillation signal, and obtaining the microphone information according to the oscillation signal and the microphone signal.

In an embodiment of the invention, step S540 further comprises the steps of generating the detection-source signals at different volume levels, and transmitting the detection-source signals at different volume levels to the detection device 200. In an embodiment of the invention, in the flow chart 500, the headset output signals respectively correspond to the detection-source signals at different volume levels, and the measured headset signals respectively correspond to the headset output signals in different levels.

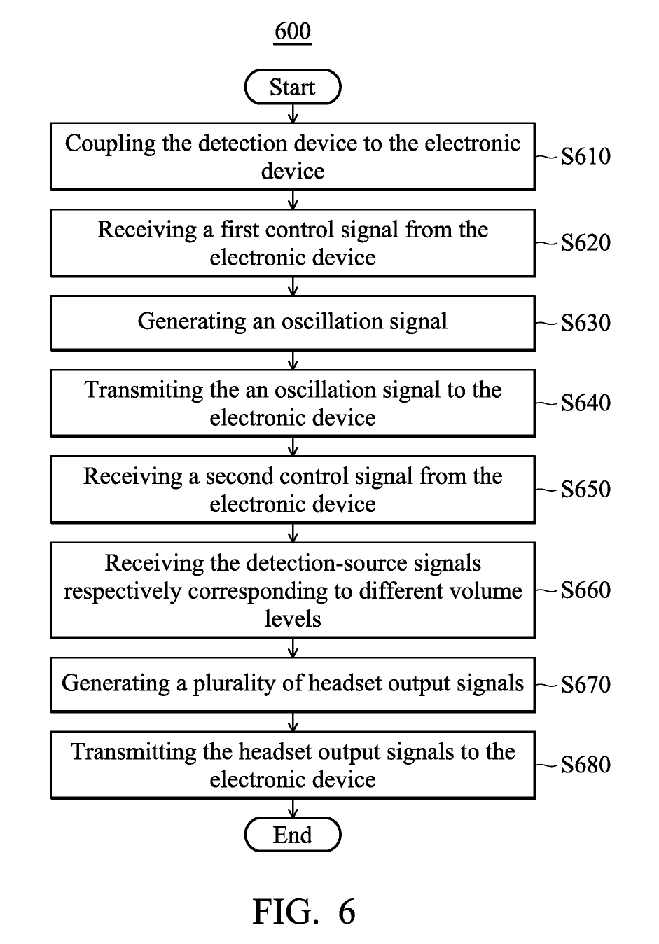

FIG. 6 is a flow chart 600 illustrating the method for setting the output of the headset according to another embodiment of the invention. The method for setting the output of the headset is applied to the detection device 200. As shown in FIG. 6, in step S610, the detection device 200 is coupled to the electronic device 100. In step S620, a first control signal (e.g. a high voltage-level control signal) is received from the electronic device 100. In step S630, an oscillation signal is generated by the detection device 200. In step S640, the oscillation signal is transmitted to the electronic device 100. In step S650, a second control signal (e.g. a low voltage-level control signal) is received from the electronic device 100. In step S660, the detection-source signals respectively corresponding to different volume levels are received from the electronic device 100. In step S670, a plurality of headset output signals are generated by the detection device 200, wherein the headset output signals corresponds to the detection-source signals respectively corresponding to different volume levels. In step S680, the headset output signals are transmitted to the electronic device 100 by the detection device 200. In this embodiment, the electronic device 100 may generate microphone information and headset information according to the oscillation signal and the headset output signals and perform a secure setting for the output of the headset of the electronic device 100.

In an embodiment of the invention, the flow chart 600 further comprises the steps of cancelling the DC components of the oscillation signal and the detection-source signals; and performing the voltage-division process for the oscillation signal and the detection-source signals which have canceled the DC components.

According to the method for setting the output of the headset of the embodiments of the invention, the user can turn the volume up or down by switching the volume levels in a safe voltage range.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device, comprising:
a first connection interface, coupling to a third connection interface of a detection device through a headset connector to receive an oscillation signal and a plurality of headset output signals corresponding to detection-source signals from the detection device and transmit the detection-source signals to the detection device;
a second connection interface, coupling to a fourth connection interface of the detection device and transmitting a control signal to the detection device;
a processor, coupling to the first connection interface and the second connection interface, obtaining microphone information according to the oscillation signal and obtaining headset information according to a plurality of measured headset signals and the microphone information; and
a storage device, coupling to the processor and storing the microphone information and the headset information.

2. The electronic device of claim 1, wherein the first connection interface corresponds to a female of the headset connector and the second connection interface corresponds to a male of the headset connector.

3. The electronic device of claim 1, wherein the second connection interface and the fourth connection interface are General-purpose input/output (GPIO).

4. The electronic device of claim 1, further comprising:
a recording device, coupling to the processor and recording a microphone signal corresponding to the oscillation signal and the plurality of measured headset signals, wherein the plurality of measured headset signals respectively correspond to the plurality of headset output signals.

5. The electronic device of claim 4, wherein the processor obtains the microphone information according to the oscillation signal and the microphone signal.

6. The electronic device of claim 5, further comprising:
a playing device, coupling to the processor and generating the detection-source signals respectively corresponding to different volume levels, wherein the plurality of headset output signals correspond to the detection-source signals respectively corresponding to different volume levels.

7. The electronic device of claim 6, wherein the processor generates the headset information according to the microphone information and the measured headset signals respectively corresponding to different volume levels.

8. The electronic device of claim 1, wherein the processor performs a secure setting according to the headset information.

9. A detection device, comprising:
a third connection interface, coupling to a first connection interface of an electronic device through a headset connector to transmit an oscillation signal and a plurality of headset output signals corresponding to detection-source signals to the electronic device, and receive the detection-source signals respectively corresponding to different volume levels from the electronic device;
a signal generator, generating the oscillation signal;
a fourth connection interface, coupling to a second connection interface of the electronic device and receiving a control signal from the electronic device; and
a switch circuit, coupling to the fourth connection interface, and coupling to the signal generator or the third connection interface according to the control signal.

10. The detection device of claim 9, further comprising:
a direct-current (DC) cancellation circuit, coupling to the switch circuit to cancel DC components of the oscillation signal and the detection-source signals; and
a bleeder circuit, coupling to the DC cancellation circuit to perform a voltage-division process for the oscillation signal and the detection-source signals which have canceled the DC components.

11. The detection device of claim 9, wherein the plurality of headset output signals corresponds to the detection-source signals respectively corresponding to different volume levels.

12. A method for setting an output of a headset, applied to an electronic device, the method comprising:
coupling the electronic device to a detection device;
receiving an oscillation signal from the detection device;
generating microphone information according to the oscillation signal;
transmitting detection-source signals to the detection device;
receiving a plurality of headset output signals corresponding to detection-source signals from the detection device;
generating a plurality of measured headset signals corresponding to the plurality of headset output signals;
obtaining headset information according to the plurality of measured headset signals and the microphone information; and
performing a secure setting for the output of the headset of the electronic device according to the headset information.

13. The method for setting the output of the headset of claim 12, further comprising:
coupling a first connection interface of the electronic device to a third connection interface of the detection device through a headset connector,
wherein the first connection interface corresponds to a female of the headset connector and the second connection interface corresponds to a male of the headset connector.

14. The method for setting the output of the headset of claim 12, further comprising:
coupling a second connection interface of the electronic device to a fourth connection interface of the detection device; and
transmitting a control signal to the fourth connection interface through the second connection interface to control a switch circuit of the detection device,
wherein the second connection interface and the fourth connection interface are General-purpose input/output (GPIO).

15. The method for setting the output of the headset of claim 12, further comprising:
recording a microphone signal corresponding to the oscillation signal and recording the plurality of measured headset signals.

16. The method for setting the output of the headset of claim 15, further comprising:
obtaining the microphone information according to the oscillation signal and the microphone signal.

17. The method for setting the output of the headset of claim 16, further comprising:
generating the detection-source signals respectively corresponding to different volume levels; and
transmitting the detection-source signals respectively corresponding to different volume levels to the detection device,
wherein the plurality of headset output signals corresponds to the detection-source signals respectively corresponding to different volume levels.

18. The method for setting the output of the headset of claim 17, further comprising:
generating the headset information according to the microphone information and the measured headset signals respectively corresponding to different volume levels.

19. A method for setting an output of a headset, applied to a detection device, the method comprising:
coupling the detection device to an electronic device;
receiving a first control signal from the electronic device;
generating an oscillation signal;
transmitting the oscillation signal to the electronic device;
receiving a second control signal from the electronic device;
receiving detection-source signals respectively corresponding to different volume levels from the electronic device; and
generating a plurality of headset output signals, wherein the plurality of headset output signals corresponds to detection-source signals respectively corresponding to different volume levels,
wherein the electronic device generates microphone information and headset information according to the oscillation signal and the plurality of headset output signals, and performs a secure setting for the output of the headset of the electronic device according to the headset information.

20. The method for setting the output of the headset of claim 19, further comprising:
cancelling DC components of the oscillation signal and the detection-source signals; and
performing a voltage-division process for the oscillation signal and the detection-source signals which have canceled the DC components.
